(19) United States
(12) Patent Application Publication
(10) Pub. No.: US 2004/0084797 A1
(43) Pub. Date: May 6, 2004

(54) Mixed resin compound, resin pipe, production of resin pipe, and photosensitive drum

(75) Inventors: Munenori Iizuka, Tokyo (JP); Kunio Machida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 10/690,504

(22) Filed: Oct. 23, 2003

Related U.S. Application Data
(62) Division of application No. 09/748,392, filed on Dec. 27, 2000.

(30) Foreign Application Priority Data
Dec. 27, 1999 (JP) 11-369777
Dec. 27, 1999 (JP) 11-369778
Dec. 27, 1999 (JP) 11-369779
Dec. 27, 1999 (JP) 11-369780
Dec. 27, 1999 (JP) 11-369781
Dec. 27, 1999 (JP) 11-369782
Dec. 27, 1999 (JP) 11-369783
Dec. 27, 1999 (JP) 11-369784

(51) Int. Cl. B29C 71/00

(52) U.S. Cl. 264/104; 264/105; 264/346

(57) ABSTRACT

Disclosed herein are a mixed resin compound, a resin pipe, a process for producing said resin pipe, and a photosensitive drum. The resin compound meets at least one of the following requirements. It is a mixture of two or more kinds of resins blended in a specific manner, it undergoes annealing under specific conditions, and it has specific values of surface roughness, Vickers hardness, coefficient of linear expansion, flexural modulus, and thermal conductivity. The resin pipe is suitable for use as the cylindrical base of the photosensitive drum for electrophotographic machines, such as copying machines, facsimiles, and printers. It is superior in surface smoothness, dimensional stability, coatability, and handlability, and hence it is very little vulnerable to damage during handling and dimensional change due to resin shrinkage and is superior in heat resistance (desirable for solvent removal) and mechanical strength (desirable for flange fitting).

### BACKGROUND OF THE INVENTION

The present invention relates to a mixed resin compound, a resin pipe, a process for production of said resin pipe, and a photosensitive drum. The photosensitive drum is used for electrophotographic apparatus such as copying machines, facsimiles, and printers.

The electrostatic recording process for copying machines, facsimiles, and printers consists of several steps. First, the photosensitive drum has its surface electrostatically charged uniformly. The charged surface of the photosensitive drum is exposed to an image projected from an optical system. The exposed part loses charge, thereby forming an electrostatic latent image, which is subsequently supplied with a toner. The toner electrostatically sticks to the photosensitive drum, thereby forming a toner image. Finally, the toner image is transferred for printing to a recording medium such as paper, OHP, photographic paper.

The above-mentioned electrostatic recording process usually employs a photosensitive drum, which consists of a cylindrical base having good conductivity, flanges firmly fitted into both ends of thereof, and a photosensitive layer formed on the outer surface thereof, as shown in FIG. 1. The photosensitive drum is rotatably supported by shafts, which are inserted into holes in the flanges and attached to the main body a of the electrophotographic apparatus. The photosensitive drum is turned by a motor through a driving gear and a driven gear formed on the flange.

The above-mentioned cylindrical base is conventionally made of aluminum alloy on account of its light weight, good machinability, and high conductivity.

Unfortunately, the cylindrical base of aluminum alloy needs precision machining to meet stringent requirements, such as dimensional accuracy and prescribed surface roughness, and to permit the flanges to fit into its ends. It occasionally needs treatment to prevent its surface oxidation. Such additional processes lead to high production cost, and hence aluminum alloy is not necessarily a satisfactory material for the cylindrical base constituting the photosensitive drum.

Meanwhile, there has been proposed an idea of making the cylindrical base from a resin compound composed mainly of polyphenylene sulfide (PPS) resin. According to this idea, it is possible to produce a light cylindrical base superior in chemical and heat resistance comparatively easily by injection molding. It is also possible to form either of the flanges 2a and 2b integrally with the cylindrical base from the same resin compound.

The PPS-based resin compound as a raw material for the cylindrical base 1 of the photosensitive drum needs to contain equal to or more than 20 weight % of carbon black to impart electrical conductivity. With such a high content of carbon black, the PPS-based resin compound is very brittle and hence needs reinforcement with glass fiber or the like, so that the resulting cylindrical base possesses required strength.

The above-mentioned conventional technology, however, has the following problems to be solved.

The PPS-based resin compound incorporated with a large amount of carbon black and reinforcing fiber is extremely poor in flowability when it is melted. Consequently, it is poor in surface transferability at the time of injection molding, and the resulting cylindrical base is poor in surface smoothness. This is disadvantageous to forming the photosensitive layer on its surface.

In addition, a resin pipe obtained by injection molding from a thermoplastic resin or a compound thereof is subject to dimensional change with time after molding. Therefore, it is not suitable for the base of the photosensitive drum which needs an extremely high dimensional accuracy.

On the other hand, the cylindrical base formed from a PPS resin compound is poor in coatability when the photosensitive layer is formed thereon. Thus, the resulting photosensitive drum does not fully exhibit its printing performance on account of its incomplete photosensitive layer. In other words, the photosensitive drum formed by coating the resin cylindrical base with a photosensitive material tends to cause defective images (such as black spots) when it runs in a laser printer.

Another disadvantage of the resin cylindrical base is that its outer surface is subject to damage at the time of demolding, annealing that follows demolding, and coating with the photosensitive material. Damages on the outer surface adversely affect coatability and result in an incomplete photosensitive layer. The state of the photosensitive layer greatly affects the printing performance of the photosensitive drum.

Moreover, any resin molded product obtained by injection molding is subject to shrinkage during cooling and curing that follow injection. This shrinkage is one of the causes to deteriorate the dimensional accuracy of the resin cylindrical base.

Another disadvantage of the resin cylindrical base is that its dimensional accuracy is affected by heating and drying which are carried out after the photosensitive layer has been formed. The photosensitive layer is formed on the outer surface of the cylindrical base by coating with a solution of a photosensitive material (such as phthalocyanine and diphenylhydrazone) and a binder in a solvent (such as alcohol, chloroform, and toluene). The coating process is followed by drying at about 100-120° C. for about 30-120 minutes for solvent removal. In this drying step, the cylindrical base is also exposed to heat and hence experiences dimensional change, with the external diameter and straightness subtly changing. This deteriorated dimensional accuracy adversely affects the performance of the photosensitive drum and hence aggravates the printing performance.

Another disadvantage of the resin cylindrical base is that it sometimes breaks when it is provided with the flange 2a or 2b. This leads to a decrease in yields.

Moreover, the resin cylindrical base is poor in coatability for the photosensitive layer. To form the photosensitive layer, the outer surface of the cylindrical base is coated with a solution of a photosensitive material (such as phthalocyanine and diphenylhydrazone) and a binder in a solvent (such as alcohol, chloroform, and toluene). Subsequently, the coating layer is dried at about 100-120° C. for about 30-120 minutes for solvent removal. The conventional resin base is slow in temperature rise in heating and drying and hence takes a long time for solvent removal. This is disadvantageous for mass production. Incomplete solvent removal results in poor images (such as black spots) at the time of printing. Thus the coatability of the photosensitive layer greatly affects the printing performance of the photosensitive drum.

### SUMMARY OF THE INVENTION

The present invention was completed in view of the foregoing. It is a first object of the present invention to provide a resin compound which gives a smooth surface even when it is incorporated with carbon black or fibrous reinforcement and also to provide a photosensitive drum whose base is made of said resin compound.

It is a second object of the present invention to provide a process for producing a resin pipe which is superior in dimensional stability and is suitable for applications (such as the base of photosensitive drums) which need high dimensional stability.

It is a third object of the present invention to provide a photosensitive drum which is superior in printing performance because its cylindrical base made of resin has good coatability for the photosensitive layer.

It is a fourth object of the present invention to provide a photosensitive drum which is superior in printing performance because its cylindrical base made of resin protects itself against surface scratches at the time of demolding and subsequent processing and also permits the photosensitive layer to be formed adequately owing to its improved coatability.

It is a fifth object of the present invention to provide a resin pipe and a photosensitive drum which are characterized by accurate outside diameter and good straightness because of their minimum shrinkage that occurs in the cooling and solidifying cycle of injection molding.

It is a sixth object of the present invention to provide a photosensitive drum which has improved dimensional accuracy because the cylindrical base of resin changes very little in outside diameter and straightness during heating and drying that follow the coating of the photosensitive layer.

It is a seventh object of the present invention to provide a photosensitive drum that can be produced efficiently in high yields with a minimum of defects due to damages to the base that occur in the step of attaching flanges to the base.

It is an eighth object of the present invention to provide a photosensitive drum which is capable of good printing without poor images (such as black spots) and is suitable for mass production owing to the cylindrical base of resin having improved coatability.

In order to achieve the first object mentioned above, the present inventors carried out experiments to find that a polyamide resin obtained from metaxylylenediamine and adipic acid or from ε-caprolactam exhibits good heat resistance, chemical resistance, and mechanical strength and readily forms a skin layer on the surface of its molded product even when it is incorporated with carbon black (as an electrically conducting material) because of its lower rate of crystallization than other crystalline resins. Therefore, this polyamide resin gives a molded product suitable for use as the base of the photosensitive drum because of its smooth surface. This finding led the present inventors to propose a resin compound based on said polyamide. (Japanese Patent Application No. Hei. 11 241247/1999).

The present inventors continued their research to find that any injection-molded product (such as the base of the photosensitive drum) obtained from a mixture of two polyamide resins with a different rate of crystallization varies in surface smoothness depending on how they are mixed. (The above-mentioned polyamide resin is slow in crystallization.) In order to obtain injection-molded products with better surface smoothness, the present inventors investigated the method of mixing more than one resin. It was found that injection molding from a mixture of resins (differing in the rate of crystallization) in their pellet form gives rise to molded products with a skin layer resulting from the slow-crystallizing resin.

A resin mixture for injection molding is usually prepared by melt-mixing from resins (each in pellet form) fed together into a mixing machine (such as twin-screw extruder). Usually, one of these resins is previously mixed with an electrically conductive material and a reinforcing material. The extrudate is pelletized. The resulting pellets are a uniform mixture of more than one resin. They undergo injection molding to give molded products of uniform resin mixture. Instead of following the above-mentioned conventional practice, the present inventors carried out injection molding without preliminary mixing by a twin-screw extruder or the like. In other words, more than one resin in pellet form were dry-blended by using a tumbler or a similar mixing machine, and the resulting mixture (in pellet form) was fed into the injection molding machine. The thus obtained resin mixture in pellet form contains the different resins in their incompletely dispersed state. In other words, the slow-crystallizing resin, which contributes to the improved surface state of the molded product, does not disperse evenly but concentrates at the surface of the molded product. In this way it is possible to obtain molded products superior in surface smoothness owing to the skin layer of the slow-crystallizing resin.

In order to achieve the above-mentioned second object, the present inventors carried out extensive studies to find that a resin pipe changes with time in dimensions after its molding in the following way. When a molten resin solidifies gradually, its molecules orient to form the most stable crystalline structure. However, in the case of injection molding, the molten resin injected into the mold cavity is cooled so rapidly that molecular orientation stops before the stable state is reached. The resulting molded product has the residual stress which gradually dissipates, causing dimensional change with time.

The present inventors' investigation revealed that it is possible to prevent dimensional change and hence to produce a resin pipe having good dimensional stability and dimensional accuracy required of the base of the photosensitive drum, if the injection-molded product undergoes annealing under adequate conditions for molecules to re-orient after demolding so that the residual stress is relieved to give a stable crystalline state.

In order to achieve the above-mentioned third object, the present inventors studied the photosensitive drum. The photosensitive drum has a photosensitive layer formed on its surface. When exposed to light (such as laser beam) from an optical system, the photosensitive layer becomes electrically charged, thereby forming images. It is a matter of course that the state of the photosensitive layer depends greatly on the dimensional accuracy of the photosensitive drum. It turned out that the printing performance of the photosensitive drum is greatly affected by the coatability of the surface of the cylindrical base on which the photosensitive layer is formed.

The present inventors carried out extensive studies to improve the coatability of the cylindrical base made of resin. It was found that coatability is greatly affected by the surface roughness of the cylindrical base and hence coatability for the photosensitive layer can be improved by improving the surface roughness of the cylindrical base. Their continued research on the specific value of surface roughness revealed that coatability for the photosensitive layer is effectively improved if the outer surface of the cylindrical base has a surface roughness equal to or smaller than 0.2 μm in terms of Ra (center line average height) and equal to or smaller than 0.8 μm in terms of Rmax (maximum height). The surface roughness specified above improves coatability for the photosensitive layer and permits the photosensitive layer to be made with high precision. Thus the resulting photosensitive drum exhibits good printing performance.

In order to achieve the above-mentioned fourth object, the present inventors carried out extensive studies to find that it is possible to minimize the possibility of the outer surface of the cylindrical base being damaged at the time of demolding and post-treatment, if the electrically conductive resin compound constituting the cylindrical base is prepared from a base resin which has a Vickers hardness no lower than 15. The cylindrical base with a minimum of damage provides good coatability for the photosensitive layer, and hence the resulting photosensitive drum exhibits good printing performance.

In order to achieve the above-mentioned fifth object, the present inventors carried out extensive studies to find that a resin pipe obtained by injection molding from a thermoplastic resin or a resin compound thereof has very little shrinkage due to cooling and solidifying after injection molding if said thermoplastic resin has a coefficient of linear expansion no larger than 1.0×10⁻⁴/K. The thus obtained resin pipe has a uniform outer diameter and good straightness, and hence it is suitable for applications that require high dimensional accuracy. In other words, the resin pipe is suitable for use as the base of the photosensitive drum.

In order to achieve the above-mentioned sixth object, the present inventors carried out extensive studies to find that the cylindrical base of the photosensitive drum formed from an electrically conductive resin compound changes due to heat very little in outside diameter and straightness if the cylindrical base has an adequate flexural modulus. Their continued investigation revealed that the cylindrical base does not change in outside diameter and straightness even when it is exposed to a small amount of heat, if it is formed from an electrically conductive resin having a flexural modulus no lower than 7.0×10³ MPa. Therefore, the cylindrical base permits the photosensitive layer to be formed thereon without decrease in dimensional accuracy. In addition, the cylindrical base decreases very little in dimensional accuracy due to shrinkage at the time of injection molding. In this way it is possible to obtain the photosensitive drum superior in dimensional accuracy.

In order to achieve the above-mentioned seventh object, the present inventors carried out extensive studies to find that the above-mentioned resin pipe permits the separately formed resin flange to be pressure-fitted into one open end thereof without damage (cracking etc.) to it, if the resin pipe is formed from a resin material having a flexural strength no lower than 100 MPa. In this way it is possible to firmly fit the flange into the resin pipe, which leads to the production of the photosensitive drum in high yields.

In order to achieve the above-mentioned eighth object, the present inventors carried out extensive studies to find that the cylindrical base of the photosensitive drum formed from an electrically conductive resin compound has extremely improved coatability for the photosensitive layer if it is improved in thermal conductivity. Their continued investigation revealed that the cylindrical base of resin is made to have a thermal conductivity no lower than 0.2 W/m·K if the composition of the electrically conductive resin compound is properly adjusted. The resulting cylindrical base permits fast solvent removal in the drying step after solution application. Thus it is possible to form the photosensitive layer readily and efficiently, which leads to the efficient production of the photosensitive drum having good printing performance.

The present invention provides a mixed resin compound, a resin pipe, a process for production of said resin pipe, and a photosensitive drum, which are explained in the following.

The first aspect of the present invention is directed to a mixed resin compound in a desired shape formed by injection molding from a molding material containing a mixed resin composed of two or more kinds of resins differing in the rate of crystallization, wherein said resins are mixed in pellet form and the resulting mixture of pellets is injection-molded as such.

The second aspect of the present invention is directed to the mixed resin compound as defined in the first aspect, wherein the mixed resin comprises (A) at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%, and (B) at least one of the other resins.

The third aspect of the present invention is directed to the mixed resin compound as defined in the first aspect, which contains an electrically conducting material dispersed therein.

The fourth aspect of the present invention is directed to the mixed resin compound as defined in the third aspect, which contains carbon black as the electrically conducting material.

The fifth aspect of the present invention is directed to the mixed resin compound as defined in the fourth aspect, which contains the carbon black in an amount of 5-30 weight %.

The sixth aspect of the present invention is directed to the mixed resin compound as defined in the first aspect, which contains a reinforcing inorganic filler.

The seventh aspect of the present invention is directed to the mixed resin compound as defined in the sixth aspect, which contains the reinforcing inorganic filler in an amount of 1-30 weight %.

The eighth aspect of the present invention is directed to a photosensitive drum consisting of a cylindrical base and a photosensitive layer formed on the outer surface thereof, wherein the cylindrical base is formed from the mixed resin compound as defined in the first aspect.

The ninth aspect of the present invention is directed to a process for producing a resin pipe by injection molding from a thermoplastic resin or a resin compound based on said thermoplastic resin, wherein the molded product undergoes annealing after demolding.

The tenth aspect of the present invention is directed to a process for producing a resin pipe as defined in the ninth aspect, wherein the resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The eleventh aspect of the present invention is directed to a process for producing a resin pipe as defined in the ninth aspect, wherein the annealing is carried out at 100-140° C. for 0.5-2 hours.

The twelfth aspect of the present invention is directed to a process for producing a resin pipe as defined in the ninth aspect, wherein the resin pipe is an electrically conductive resin pipe formed by injection molding from an electrically conductive resin compound composed of a thermoplastic resin and an electrically conducting material dispersed therein.

The thirteenth aspect of the present invention is directed to a process for producing a resin pipe as defined in the twelfth aspect, wherein the electrically conductive resin compound contains carbon black as an electrically conducting material.

The fourteenth aspect of the present invention is directed to a process for producing a resin pipe as defined in the thirteenth aspect, wherein the content of the carbon black is 5-30 weight %.

The fifteenth aspect of the present invention is directed to a process for producing a resin pipe as defined in the ninth aspect, wherein the electrically conductive resin compound is one which contains a reinforcing inorganic filler dispersed therein.

The sixteenth aspect of the present invention is directed to a process for producing a resin pipe as defined in the fifteenth aspect, wherein the content of the reinforcing inorganic filler is 1-30 weight %.

The seventeenth aspect of the present invention is directed to a process for producing a resin pipe as defined in the ninth aspect, wherein the resin pipe is a base for a photosensitive drum.

The eighteenth aspect of the present invention is directed to a photosensitive drum consisting of a cylindrical base of electrically conductive resin compound and a photosensitive layer formed by coating on the outer surface of said cylindrical base, wherein the outer surface of the cylindrical base has a surface roughness equal to or smaller than 0.2 μm in terms of Ra (center line average height) and equal to or smaller than 0.8 μm in terms of Rmax (maximum height).

The nineteenth aspect of the present invention is directed to a photosensitive drum as defined in the eighteenth aspect, wherein the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The twentieth aspect of the present invention is directed to a photosensitive drum as defined in the eighteenth aspect, wherein the electrically conductive resin compound contains carbon black as an electrically conducting material.

The twenty-first aspect of the present invention is directed to a photosensitive drum as defined in the twentieth aspect, wherein the content of the carbon black is 5-30 weight %.

The twenty-second aspect of the present invention is directed to a process for producing a resin pipe as defined in the eighteenth aspect, wherein the electrically conductive resin compound is one which contains a reinforcing inorganic filler dispersed therein.

The twenty-third aspect of the present invention is directed to a photosensitive drum as defined in the twenty-second aspect, wherein the content of the reinforcing inorganic filler is 1-30 weight %.

The twenty-fourth aspect of the present invention is directed to a photosensitive drum consisting of a cylindrical base and a photosensitive layer formed by coating on the outer surface thereof, wherein the cylindrical base is an electrically conductive resin pipe formed from an electrically conductive resin compound which contains as a base resin having a Vickers hardness no lower than 15.

The twenty-fifth aspect of the present invention is directed to a photosensitive drum as defined in the twenty-fourth aspect, wherein the base resin of the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The twenty-sixth aspect of the present invention is directed to a photosensitive drum as defined in the twenty-fourth aspect, wherein the electrically conductive resin compound contains carbon black as an electrically conducting material.

The twenty-seventh aspect of the present invention is directed to a photosensitive drum as defined in the twenty-sixth aspect, wherein the content of the carbon black is 5-30 weight %.

The twenty-eighth aspect of the present invention is directed to a photosensitive drum as defined in the twenty-fourth aspect, wherein the electrically conductive resin compound is one which contains a reinforcing inorganic filler dispersed therein.

The twenty-ninth aspect of the present invention is directed to a photosensitive drum as defined in the twenty-eighth aspect, wherein the content of the reinforcing inorganic filler is 1-30 weight %.

The thirtieth aspect of the present invention is directed to a resin pipe obtained by injection molding from a thermoplastic resin or a resin compound based on said thermoplastic resin, wherein said thermoplastic resin or the base resin for said resin compound is a resin having a coefficient of linear expansion no larger than 1.0×10⁻⁴/K.

The thirty-first aspect of the present invention is directed to a resin pipe as defined in the thirtieth aspect, which contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The thirty-second aspect of the present invention is directed to a resin pipe as defined in the thirtieth aspect, wherein the resin pipe is an electrically conductive resin pipe formed by injection molding from an electrically conductive resin compound composed of a thermoplastic resin and an electrically conducting material dispersed therein.

The thirty-third aspect of the present invention is directed to a resin pipe as defined in the thirty-second aspect, wherein the electrically conductive resin compound contains carbon black as an electrically conducting material.

The thirty-fourth aspect of the present invention is directed to a resin pipe as defined in the thirty-third aspect, wherein the content of the carbon black is 5-30 weight %.

The thirty-fifth aspect of the present invention is directed to a resin pipe as defined in the thirtieth aspect, wherein the electrically conductive resin compound is one which contains a reinforcing inorganic filler dispersed therein.

The thirty-sixth aspect of the present invention is directed to a resin pipe as defined in the thirty-fifth aspect, wherein the content of the reinforcing inorganic filler is 1-30 weight %.

The thirty-seventh aspect of the present invention is directed to a resin pipe as defined in the thirtieth aspect, wherein the resin pipe is a base for a photosensitive drum.

The thirty-eighth aspect of the present invention is directed to a photosensitive drum consisting of a cylindrical base and a photosensitive layer formed by coating on the outer surface thereof, wherein the cylindrical base is a resin pipe defined in the thirtieth aspect.

The thirty-ninth aspect of the present invention is directed to a photosensitive drum consisting of a cylindrical base and a photosensitive layer formed from a solution containing a photosensitive material by coating on the outer surface thereof, wherein the cylindrical base is an electrically conductive resin pipe formed from an electrically conductive resin compound which has a flexural modulus no lower than 7×10³ MPa.

The fortieth aspect of the present invention is directed to a photosensitive drum as defined in the thirty-ninth aspect, wherein the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The forty-first aspect of the present invention is directed to a photosensitive drum as defined in the thirty-ninth aspect, wherein the electrically conductive resin compound contains carbon black as an electrically conducting material.

The forty-second aspect of the present invention is directed to a photosensitive drum as defined in the forty-first aspect, wherein the content of the carbon black is 5-30 weight %.

The forty-third aspect of the present invention is directed to a photosensitive drum as defined in the thirty-ninth aspect, wherein the electrically conductive resin compound is one which contains a reinforcing inorganic filler dispersed therein.

The forty-fourth aspect of the present invention is directed to a photosensitive drum as defined in the forty-third aspect, wherein the content of the reinforcing inorganic filler is 1-30 weight %.

The forty-fifth aspect of the present invention is directed to a photosensitive drum made up of a resin pipe as a base, a photosensitive layer formed on the outer surface of the base, and a separately formed resin flange pressure-fitted into at least one open end of the base, wherein the resin pipe is formed from a resin material having a flexural strength no lower than 100 MPa.

The forty-sixth aspect of the present invention is directed to a photosensitive drum as defined in the forty-fifth aspect, wherein the resin material from which the resin pipe is formed is an electrically conductive resin compound containing at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The forty-seventh aspect of the present invention is directed to a photosensitive drum as defined in the forty-fifth aspect, wherein the electrically conductive resin compound from which the resin pipe is formed contains carbon black as an electrically conducting material.

The forty-eighth aspect of the present invention is directed to a photosensitive drum as defined in the forty-seventh aspect, wherein the content of the carbon black is 5-30 weight %.

The forty-ninth aspect of the present invention is directed to a photosensitive drum as defined in the forty-fifth aspect, wherein the electrically conductive resin compound is one which contains a reinforcing inorganic filler dispersed therein.

The fiftieth aspect of the present invention is directed to a photosensitive drum as defined in the forty-ninth aspect, wherein the content of the reinforcing inorganic filler is 1-30 weight %.

The fifty-first aspect of the present invention is directed to a photosensitive drum consisting of a cylindrical base and a photosensitive layer formed on the outer surface thereof by coating and drying from a solution containing a photosensitive material, wherein the cylindrical base is an electrically conductive resin pipe formed from an electrically conductive resin having a thermal conductivity no lower than 0.2 W/m·K.

The fifty-second aspect of the present invention is directed to a photosensitive drum as defined in the fifty-first aspect, wherein the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The fifty-third aspect of the present invention is directed to a photosensitive drum as defined in the fifty-first aspect, wherein the electrically conductive resin compound contains carbon black as an electrically conducting material.

The fifty-fourth aspect of the present invention is directed to a photosensitive drum as defined in the fifty-third aspect, wherein the content of the carbon black is 5-30 weight %.

The fifty-fifth aspect of the present invention is directed to a photosensitive drum as defined in the fifty-first aspect, wherein the electrically conductive resin compound is one which contains a reinforcing inorganic filler dispersed therein.

The fifty-sixth aspect of the present invention is directed to a photosensitive drum as defined in the fifty-fifth aspect, wherein the content of the reinforcing inorganic filler is 1-30 weight %.

### BRIEF DESCRIPTION OF THE DRAWING

FIG. 1 is a schematic sectional view showing one example of the photosensitive drum.

### DETAILED DESCRIPTION OF THE PREFERRED EMBODIMENTS

A detailed description of the invention follows.

The first aspect of the present invention to achieve the first object mentioned above is directed to a mixed resin composition which is formed by injection molding, without preliminary mixing, from a mixed resin in pellet form composed of two or more kinds of resins in pellet form differing in the rate of crystallization.

The resin materials to be mixed are not specifically restricted so long as they differ in the rate of crystallization. The one having a lower rate of crystallization forms a skin layer in the surface of the molded product. It should be at least one kind of resin selected from a polyamide resin obtained from metaxylylenediamine and adipic acid, a polyamide resin obtained from ε-caprolactam, and an alloy resin obtained by blending a polyamide resin with a resin having a water absorption no higher than 0.3%. This resin is desirable because it gives a skin layer superior in heat resistance, chemical resistance, and mechanical strength. This polyamide resin (PA) gives the cylindrical base for the photosensitive drum having good surface smoothness even though it is incorporated with a large amount of electrically conducting material and reinforcing material to impart electrical conductivity and to improve mechanical strength.

The polyamide resin obtained from metaxylylenediamine and adipic acid by polycondensation reaction is what is generally called nylon MXD6. The polyamide resin obtained from ε-caprolactam by ring-opening polymerization reaction is what is generally called nylon-6.

The alloy resin obtained by blending the polyamide resin with a resin having a water absorption no higher than 0.3% is desirable for the following reasons.

There has been proposed an idea of forming the cylindrical base from a polyamide-based electrically conductive resin. The polyamide resin (PA) for this purpose has a higher water absorption (measured according to ASTM D-570) than other resins. For example, PA66 has a value of 0.6-3% and PA6 has a value of 0.7-1.8%. Molded products with such a high water absorption may pose a problem with dimensional accuracy. That is, they expand due to water absorption when they are allowed to stand in an atmosphere at 30° C. and above and 90% RH and above for 2-3 hours. Expansion may adversely affect the function of the photosensitive body and hence greatly aggravates the image quality.

According to the present invention, the polyamide resin having a high water absorption is blended with a resin having a water absorption no higher than 0.3%, and the resulting resin alloy is used as the base material. The resulting resin compound has a low water absorption and is little subject to dimensional change in a high-temperature high-humidity environment.

The polyamide resin for the resin alloy may be any known polyamide resin, such as nylon MXD6, nylon-6, nylon-11, nylon-12, nylon-46, nylon-66, nylon-610, nylon-612, nylon-1212, and copolymers thereof. There are no specific restrictions on their selection.

The low water absorption resin for the resin alloy (referred to as the blending resin) includes PP (polypropylene), PPE (polyphenylene ether), and PPS (polyphenylene sulfide) and the like, with the second and third being preferable and the second being most desirable.

The resin alloy according to the present invention may be obtained by blending the polyamide resin (such as PA66) with the blending resin in an amount of 1-70 weight %, preferably 5-50 weight %, and more preferably 10-40 weight %.

Blending may be facilitated by the aid of a compatibilizing agent to improve the compatibility of the two resin components. Good compatibility contributes to good mechanical properties (mechanical strength), low water absorption, and high chemical resistance. Examples of the compatibilizing agent include maleic acid-modified polypropylene (PP) for the PA-PP system and a copolymer of epoxy-modified polystyrene (PS) and polymethyl methacrylate (PMMA) for the PA-PPS or PA-PPE system.

The resin alloy composed of the polyamide resin and the blending resin gives a molded product which has better dimensional stability than that obtained from the polyamide resin alone, as mentioned above. This is demonstrated by Referential Examples as shown in Table 1 below. The water absorption and dimensional change in Table 1 are expressed in terms of difference between values measured before and after standing for 24 hours in a constant-temperature constant-humidity bath at 50° C. and 95% RH. It is noted that the water absorption and dimensional stability of the molded product are greatly improved when the polyamide resin is blended with the blending resin having a low water absorption.

TABLE 1

| | | | | | | Reinforcing | | Dimensional |
|---|---|---|---|---|---|---|---|---|
| | | | | | Conducting | material | Water | change (%) |
| | | | | | material | (weight %) | absorption | Dimensional |
| | Resin | | | | (weight %) | Potassium | (%) | change in |
| | (weight %) | | | | Ketjen | titanate | ASTM | flow |
| | PA66 | PPE | PPS | PP | black | whisker | D-570 | direction |
| Water | 1.80 | 0.10 | 0.02 | 0.01 | | | | |
| Absorption | | | | | | | | |
| (%) ASTM | | | | | | | | |
| D-570 | | | | | | | | |
| Referential | | | | | | | | |
| example | | | | | | | | |
| 1 | 70 | | | | 10 | 10 | 1.6 | 1.12 |
| 2 | 70 | | | | 10 | 20 | 1.5 | 1.05 |
| 3 | 70 | | | | 10 | 30 | 1.3 | 0.95 |
| 4 | 42 | 28 | | | 10 | 20 | 0.4 | 0.3 |
| 5 | 42 | | 28 | | 10 | 20 | 0.2 | 0.2 |
| 6 | 42 | | | 28 | 10 | 20 | 0.3 | 0.4 |

The above-mentioned nylon MXD6, nylon-6 and/or the alloy resin obtained by blending the polyamide resin with a resin having a water absorption of 0.3% or less is combined with a resin having a higher rate of crystallization. This resin is the base resin (quantity-wise and quality-wise) of the mixed resin compound pertaining to the present invention. It is selected adequately according to uses. It is not specifically restricted; however, it should preferably be nylon-11, nylon-12, nylon-46, nylon-66, nylon-610, nylon-612, nylon-1212, or a copolymer thereof. These polyamide resins are recommended in the case where the cylindrical base for the photosensitive drum is intended.

The mixing ratio of these resin components is not specifically restricted; it should be established according to the kind of the resin used and the use of the mixed resin compound. In the case where the cylindrical base for the photosensitive drum is formed from a mixture of the nylon MXD6 nylon-6 and/or the alloy resin obtained by blending the polyamide resin with a resin having a water absorption of 0.3% or less with the above-mentioned other polyamide resin, the amount of the former is usually 5-40 parts by weight, particularly 10-25 parts by weight, and the amount of the latter is 100 parts by weight.

The mixed resin compound according to the first aspect of the present invention may be incorporated with an electrically conducting material to impart electrical conductivity according to use. The electrically condutive material is not specifically restricted so long as it is capable of uniform dispersion into the above-mentioned resin. It includes, for example, carbon black, graphite, aluminum powder, copper powder, nickel powder, and electrically conductive glass powder. Carbon black is preferable. The amount of the electrically conductive material is not specifically restricted; it may range from 5 to 30 weight %, particularly 5-20 weight %, of the compound. In the case where the resin compound is intended for the cylindrical base of the photosensitive drum, the amount of the electrically conductive material should be adjusted such that the resulting molded product has a surface resistance equal to or lower than 10⁶ Ω/□, preferably equal to or lower than 10⁵ Ω/□, more preferably equal to or lower than 10⁴ Ω/□.

In addition, the resin compound may be incorporated with a variety of inorganic fillers (such as fibers) for reinforcement and extension. Examples of inorganic fillers include carbon fiber, electrically conductive or non-conductive whisker, and electrically conductive or non-conductive glass fiber. The electrically conductive fibers may also serve as the conducting material. In the case where electrically conductive fiber is used, the conducting material should be used in a reduced amount.

The inorganic filler is used in varied amounts without restrictions according to its kind and fiber length and diameter. It should be added in an amount of 1-30 weight %, preferably 5-25 weight %, more preferably 10-25 weight %, of the resin compound. According to the present invention, the inorganic filler remarkably improves the strength and stiffness of the molded produce without adverse effect on its surface smoothness.

The above-mentioned mixed resin compound may be incorporated with, in addition to the above-mentioned conducting material and inorganic filler, any known additives, such as polytetrafluoroethylene (PTFE), silicone, molybdenum sulfide, (MOS₂), and metal soap, in an adequate amount. Moreover, the above-mentioned conducting material and inorganic filler may be given surface treatment with silane coupling agent or titanate coupling agent.

The mixed resin compound pertaining to the first aspect of the present invention is a mixture prepared by mixing the above-mentioned base resin with the above-mentioned slow-crystallizing resin to form a skin layer, both resins in pellet form. The resulting mixture of pellets is fed as such into an injection molding machine. The mixing of pellets may be accomplished by using any known mixing machine such as tumblers capable of dry blending. In the case where the mixed resin compound is incorporated with the above-mentioned inorganic fillers (such as conducting material and reinforcing material), it is desirable (although not mandatory) that they should be preliminarily incorporated into the pellets of the base resin by kneading. Injection molding may be carried out under ordinary conditions (in terms of temperature and pressure).

The mixed resin compound pertaining to the first aspect of the present invention will find use in various applications. Due to the fact that it forms a skin layer on its molded product and hence it provides a smooth surface even thought it is incorporated with additives (such as conducting material and reinforcing material), its preferred applications include the cylindrical base for the photosensitive drum which needs good chemical resistance, mechanical strength, and surface smoothness.

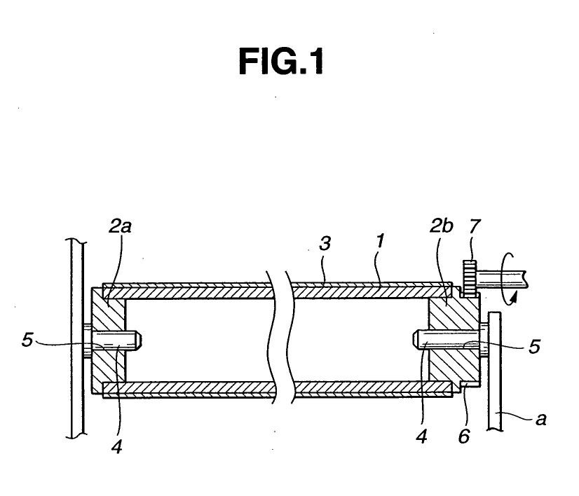

The photosensitive drum just mentioned above consists of a cylindrical base 1 and a photosensitive layer 3 formed on its outer surface as shown in FIG. 1. The cylindrical base 1 is obtained by molding from the mixed resin compound pertaining to the first aspect of the present invention. Usually, the mixed resin compound contains the above-mentioned conducting material so that it has adequate conductivity and also contains the above-mentioned inorganic filler for reinforcement. Their mixing conditions are as mentioned above.

The photosensitive drum shown in FIG. 1 is constructed such that the cylindrical base 1 has separately molded flanges 2a and 2b firmly fitted into both ends thereof. Either of the flanges 2a and 2b may be formed integrally with the cylindrical base 1 from the electrically conductive resin compound pertaining to the present invention. In this case, it is possible to form the driving gear 6 integrally with the cylindrical base from the mixed resin compound pertaining to the present invention because the mixed resin compound pertaining to the first aspect of the present invention gives a molded product having high strength and stiffness when it is incorporated with a reinforcing inorganic filler.

The outer surface of the cylindrical base 1 should preferably (although not mandatory) have a surface roughness such that the center line average height (Ra) is equal to or smaller than 0.8 μm, particularly equal to or smaller than 0.2 μm, the maximum height (Rmax) is equal to or smaller than 1.6 μm, particularly equal to or smaller than 0.8 μm, and the ten-point average height (Rz) is equal to or smaller than 1.6 μm, particularly equal to or smaller than 0.8 μm. With excessively large values of Ra, Rmax, and Rz, the outer surface of the cylindrical base 1 has surface irregularities which manifest themselves through the photosensitive layer 3 formed thereon. Such surface irregularities cause poor images. The above-mentioned desirable surface smoothness can be easily achieved by using the mixed resin compound pertaining to the first aspect of the present invention even though the resin compound is incorporated with an inorganic filler for reinforcement.

The photosensitive layer 3 on the outer surface of the cylindrical base 1 may be formed in any known layer structure from any known material.

The structure of the photosensitive drum is not limited to the one shown in FIG. 1. For example, the flanges 2a and 2b may have protruding shafts instead of the holes 5 to receive shafts. The protruding shafts permit the photosensitive drum to be rotatably mounted on the electrophotographic apparatus. The shape of the flanges 2a and 2b and the method of driving the photosensitive drum and other structure may be changed in any manner within the scope of the present invention.

The second aspect of the present invention is directed to a resin pipe formed by injection molding and ensuing annealing from a thermoplastic resin or a resin compound based on said thermoplastic resin.

The above-mentioned thermoplastic resin or the above-mentioned resin compound based thereon is not specifically restricted so long as it can be formed into pipe by injection molding; they are properly selected according to the applications of the resin pipe to be made. In the case where the resin pipe is used as the base of the photosensitive drum, the thermoplastic should preferably be a polyamide resin (or nylon resin) which gives a resin pipe having good mechanical strength and smooth surface (which is desirable for the photosensitive layer). This polyamide resin is the same one as illustrated in the first aspect of the present invention. It is desirable to use at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%, on account of their good dimensional stability attained by annealing.

According to the present invention, the molding material may be a mixture of resins or a mixture of the above-mentioned nylon MXD6 nylon-6 and/or the alloy resin obtained by blending the polyamide resin with a resin having a water absorption of 0.3% or less with another resin. Examples of another resin include nylon-11, nylon-12, nylon-46, nylon-66, nylon-610, nylon-612, nylon-1212, or a copolymer thereof. Their mixing ratio is not specifically restricted. However, it is desirable that the nylon MXD6 or nylon-6 or the alloy resin obtained by blending the polyamide resin with a resin having a water absorption of 0.3% or less a mixture thereof should account for 30-100 weight %, preferably 40-100 weight %, in the mixture.

The conducting material, inorganic filler or any known additives may be incorporated with the same additives as those mentioned in the first aspect of the present invention. The amount of such additives is the same as that in the first aspect of the present invention.

In the second aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance equal to or lower than 10⁶ Ω/□, preferably equal to or lower than 10⁵ Ω/□, more preferably equal to or lower than 10⁴ Ω/□.

In the second aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness.

The photosensitive drum according to the second aspect of the present invention is a cylindrical body whose base is formed from the above-mentioned electrically conductive resin compound. The cylindrical base may be formed by any known method, such as injection molding and extrusion molding, the former being preferable. Molding may be carried out under ordinary conditions (for temperature and pressure).

The second aspect of the present invention is intended to provide a resin pipe which has its dimensional stability improved by annealing after demolding.

This annealing is accomplished by heating, after demolding, the molded product in a constant-temperature bath or the like. Annealing conditions are not specifically restricted but are selected according to the molding material used. Annealing temperature is usually 100-140° C., particularly 100-130° C., and annealing time is usually 0.5-2 hours, particularly 1-1.5 hours. Annealing at lower temperatures than specified above takes a longer time than 5 hours, with insufficient stress release. Annealing at higher temperatures in excess of 140° C. will cause resin decomposition and deformation, producing an adverse effect on the molded product.

The above-mentioned annealing should be performed usually at 100-140° C., preferably at 100-125° C., more preferably at 115-120° C., and usually for 0.5-2 hours, preferably for 1-1.5 hours, on the resin compound which contains as its component a polyamide resin obtained from metaxylylenediamine and adipic acid, a polyamide resin obtained from ε-caprolactam, and an alloy resin obtained by blending a polyamide resin with a resin having a water absorption no higher than 0.3%. Annealing in this manner ensures stress release and leads to a stable crystalline structure.

The molding method according to the second aspect of the present invention is adequately applied to the production of the resin pipe (the cylindrical base for the photosensitive drum) which needs high dimensional accuracy.

The photosensitive drum shown in FIG. 1 consists of a cylindrical base 1 and separately molded flanges 2a and 2b which are firmly fitted into both ends of the cylindrical base 1. Either of the flanges 2a and 2b may be formed integrally with the cylindrical base 1 by the molding method according to the second aspect of the present invention mentioned above. The flange has high strength and stiffness if it is formed from the above-mentioned resin compound incorporated with an inorganic filler, so that the flange may be formed integrally with the driving gear 6.

In the case where the thus obtained resin pipe is used as the base of the photosensitive drum, it is desirable to finish its outer surface in such a way that it has the surface roughness as specified in the first aspect of the present invention.

The resin pipe obtained by the method according to the second aspect of the present invention is suitable for use as the base of the photosensitive drum which needs high dimensional accuracy. However, its use is not limited to this.

The photosensitive drum according to the third aspect of the present invention (to achieve the third object of the present invention) consists of a cylindrical base of resin and a photosensitive layer formed thereon by coating, the outer surface of said cylindrical base having a surface roughness such that the center line average height (Ra) is equal to or smaller than 0.2 μm and the maximum height (Rmax) is equal to or smaller than 0.8 μm.

The above-mentioned cylindrical base is formed from an electrically conductive resin compound which is composed of a thermoplastic resin and a conducting material added thereto to impart conductivity. The resin component for the electrically conductive resin compound is not specifically restricted so long as it gives the surface roughness as specified above. A polyamide resin is preferable on account of its good chemical resistance and mechanical strength. It is at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%. They gives a molded product having good surface smoothness.

The components to be incorporated into the resin compound are the same as those mentioned in the second aspect of the present invention. Their amount is the same as that in the second aspect of the present invention.

In the third aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance equal to or lower than 10⁶ Ω/□, preferably equal to or lower than 10⁵ Ω/□, more preferably equal to or lower than 10⁴ Ω/□.

In the third aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness.

The photosensitive drum according to the third aspect of the present invention is a cylindrical body whose base is formed from the above-mentioned electrically conductive resin compound. The cylindrical base may be formed by any known method, such as injection molding and extrusion molding, the former being preferable. Molding may be carried out under ordinary conditions (for temperature and pressure).

The photosensitive drum according to the third aspect of the present invention is characterized in that its cylindrical base has its surface controlled such that the center average height (Ra) is equal to or smaller than 0.2 μm, preferably equal to or smaller than 0.15 μm, and the maximum height (Rmax) is equal to or smaller than 0.8 μm, preferably equal to or smaller than 0.6 μm. Owing to this controlled surface roughness, the outer surface of the cylindrical base has good coatability for the photosensitive layer, which contributes to the high-performance photosensitive drum. The outer surface of the cylindrical base should preferably be as smooth as possible; however, Ra is usually 0.2-0.5 μm and Rmax is usually 0.8-1.0 μm in view of the resin properties and production cost.

The above-mentioned surface roughness may be adjusted by controlling the composition of the electrically conductive resin compound. To this end, it is necessary to select the resin component, reinforcing inorganic filler, conducting material, and their mixing ratio. The resin component of the electrically conductive resin compound should preferably be at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%. It gives a molded product which affords the desired surface roughness without requiring mechanical treatment (such as polishing) even in the case where the resin compound is incorporated with a reinforcing inorganic filler.

The cylindrical base constituting the photosensitive drum according to the third aspect of the present invention is the resin pipe having the surface roughness as mentioned above. Usually, the cylindrical base has separately molded flanges 2a and 2b firmly fitted into its ends as shown in FIG. 1. Either of the flanges 2a and 2b may be formed integrally with the cylindrical base. The flange has high strength and stiffness if it is formed from the above-mentioned resin compound incorporated with an inorganic filler, so that the flange may be formed integrally with the driving gear 6.

The photosensitive drum according to the third aspect of the present invention consists of the cylindrical base 1 and the photosensitive layer 3 formed on the outer surface of the cylindrical base 1, as shown in FIG. 1. The photosensitive layer 3 is formed by coating the outer surface of the cylindrical base 1 with a solution of a photosensitive material and a binder in an organic solvent (such as alcohol, chloroform, and toluene). The coating layer is subsequently dried by heating. The cylindrical base 1 offers good coatability because its outer surface has good surface smoothness, and hence the resulting photosensitive drum has the defect-free photosensitive layer and exhibits outstanding printing performance. Incidentally, the coating solution for the photosensitive layer 3 may be any known one and the layer structure of the photosensitive layer 3 may also be any known one.

The photosensitive drum according to the fourth aspect of the present invention to achieve the fourth object of the present invention is characterized in that its cylindrical base is a resin pipe formed from an electrically conductive resin compound which is based on a resin having a Vickers hardness no lower than 15.

The base resin for the electrically conductive resin compound is not specifically restricted so long as it has a Vickers hardness no lower than 15, preferably no lower than 20. A polyamide resin is preferable because of its good chemical resistance and mechanical strength and its ability to give good surface smoothness. It is at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The components to be incorporated into the resin compound are the same as those mentioned in the second aspect of the present invention. Their amount is the same as that in the second aspect of the present invention.

In the fourth aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance equal to or lower than 10⁶ Ω/□, preferably equal to or lower than 10⁵ Ω/□, more preferably equal to or lower than 10⁴ Ω/□.

In the fourth aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness.

The photosensitive drum according to the fourth aspect of the present invention is characterized in that its cylindrical base is formed from the above-mentioned electrically conductive resin compound whose base resin has a Vickers hardness no lower than 15, preferably no lower than 20. The cylindrical base formed from such a resin compound has the outer surface which is very little vulnerable to damage at the time of demolding and post-treatment. Thus the outer surface of the cylindrical base offers good coatability for the photosensitive layer. This leads to good printing performance.

The photosensitive drum according to the fourth aspect of the present invention is a cylindrical body whose base is formed from the above-mentioned electrically conductive resin compound. The cylindrical base may be formed by any known method, such as injection molding and extrusion molding, the former being preferable. Molding may be carried out under ordinary conditions (for temperature and pressure).

The cylindrical base formed from the electrically conductive resin compound should have its outer surface controlled such that the surface roughness is identical with that in the first aspect of the present invention.

The photosensitive drum according to the fourth aspect of the present invention is constructed of a cylindrical base which is an electrically conductive resin pipe formed from an electrically conductive resin compound whose base resin has a Vickers hardness no lower than 15. The cylindrical base is formed by injection molding or the like and then its outer surface is coated with a photosensitive layer. In this way the photosensitive drum is completed. According to the fourth aspect of the present invention, it is possible to form the photosensitive layer adequately because the cylindrical base is very little vulnerable to damage at the time of demolding and coating. In addition, prior to the coating of the photosensitive layer, the cylindrical base may undergo annealing at a prescribed temperature for a prescribed period of time after demolding. During such annealing and post-treatment, the cylindrical base protects its surface from damage. Incidentally, the annealing may be carried out under the same conditions as mentioned in the second aspect of the present invention.

The photosensitive layer on the outer surface of the cylindrical base may be formed from any known material of known composition. In addition, the photosensitive layer may have any known layer structure and may be formed by any known coating method. To be concrete, a photosensitive material, in conjunction with a binder, is dissolved in an organic solvent and the resulting solution is applied to the outer surface of the cylindrical base. The coating layer is subsequently dried for solvent removal by heating at a prescribed temperature for a prescribed period of time.

The cylindrical base has separately molded flanges 2a and 2b firmly fitted into both ends thereof, as shown in FIG. 1. At least either of the flanges 2a and 2b may be formed integrally with the cylindrical base from the above-mentioned electrically conductive resin compound pertaining to the present invention. The flange has high strength and stiffness owing to incorporation with the above-mentioned inorganic filler for reinforcement, so that the flange may be formed integrally with the driving gear 6.

The resin pipe according to the fifth aspect of the present invention to achieve the fifth object of the present invention is formed by injection molding from a thermoplastic resin or a resin compound based on said thermoplastic resin, wherein said thermoplastic resin has a coefficient of linear expansion no larger than 1.0×10⁻⁴/K.

The thermoplastic resin mentioned above is not specifically restricted so long as it has a coefficient of linear expansion no larger than 1.0×10⁻⁴/K and is capable of injection molding into pipe. An adequate one is selected according to the use of the resin pipe. In the case where the resin pipe is used as the base of the photosensitive drum, it should preferably be formed from a polyamide resin (nylon resin) because of good mechanical strength and ability to form a smooth surface suitable for the photosensitive layer to be formed thereon. A preferred polyamide with a comparatively small coefficient of linear expansion is at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The components to be incorporated into the resin compound are the same as those mentioned in the second aspect of the present invention. Their amount is the same as that in the second aspect of the present invention.

In the fifth aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance equal to or lower than 10⁶ Ω/□, preferably equal to or lower than 10⁵ Ω/□, more preferably equal to or lower than 10⁴ Ω/□.

In the fifth aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness.

The resin pipe according to the fifth aspect of the present invention is a cylindrical body whose base is formed from the above-mentioned electrically conductive resin compound. The cylindrical base may be formed by any known method, such as injection molding and extrusion molding, the former being preferable. Molding may be carried out under ordinary conditions (for temperature and pressure).

The resin pipe according to the fifth aspect of the present invention is formed from a thermoplastic resin or a resin compound, wherein said thermoplastic resin or the base resin of said resin compound has a coefficient of linear expansion no larger than 1.0×10⁻⁴/K, preferably no larger than 8.0×10⁻⁵/K. Because of this property, the resin pipe is very little subject to shrinkage at the time of cooling and solidifying that follows injection molding and hence has good dimensional accuracy in outside diameter and straightness. The coefficient of linear expansion should preferably be as small as possible from the standpoint of dimensional accuracy. It is usually 5.0×10⁻⁵ to 15×10⁻⁵/K, particularly 5.0×10⁻⁵ to 9×10⁻⁵/K. Incidentally, it is measured by the method provided in ASTM D-696.

In the case of the resin pipe according to the fifth aspect of the present invention, it is recommended that it should have surface roughness identical with that specified in the first aspect of the present invention.

The resin pipe according to the fifth aspect of the present invention is suitable for use as the base for the photosensitive drum. The resin pipe as the base 1 has its outer surface coated with the photosensitive layer 3, so that the photosensitive drum is constructed. The photosensitive layer 3 may be formed from any known material of any known composition. In addition, the photosensitive layer may have any known layer structure, which may be identical with that in the third aspect of the present invention.

The resin pipe according to the fifth aspect of the present invention is suitable for use as the base for the photosensitive drum which needs high dimensional accuracy. However, its use is not limited to this.

The photosensitive drum according to the sixth aspect of the present invention to achieve the sixth object of the present invention is based on the resin pipe (as the cylindrical base) which is formed from an electrically conductive resin compound having a flexural modulus no lower than 7×10³ MPa.

The resin component for the above-mentioned electrically conductive resin compound is not specifically restricted so long as it has a flexural modulus as mentioned above. A polyamide resin is preferable because of its good chemical resistance and mechanical strength and its ability to give good surface smoothness. It is at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The components to be incorporated into the resin compound are the same as those mentioned in the second aspect of the present invention. Their amount is the same as that in the second aspect of the present invention.

In the sixth aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance lower than 10⁶ Ω/□, preferably lower than 10⁵ Ω/□, more preferably lower than 10⁴ Ω/□.

In the sixth aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness. The surface roughness is identical with that in the first aspect of the present invention.

The photosensitive drum according to the sixth aspect of the present invention is a cylindrical body whose base is formed from the above-mentioned electrically conductive resin compound. The cylindrical base may be formed by any known method, such as injection molding and extrusion molding, the former being preferable. Molding may be carried out under ordinary conditions (for temperature and pressure).

The photosensitive drum according to the sixth aspect of the present invention is characterized in that its cylindrical base is formed from the above-mentioned electrically conductive resin compound which has a flexural modulus no lower than 7×10³ MPa, preferably no lower than 8×10³ MPa. Because of this property, the resulting cylindrical base changes very little in outside diameter and straightness when its outer surface undergoes coating for the photosensitive layer and subsequent drying with heat. Therefore, the photosensitive drum obtained from the cylindrical base has improved dimensional accuracy. If the electrically conductive resin compound has a flexural modulus lower than 7×10³ MPa, the cylindrical base greatly changes in outside diameter and straightness in the step of drying with heat that follows the coating of the photosensitive layer. Therefore, the resulting photosensitive drum is poor in dimensional accuracy and printing performance, and it does not achieve the object of the present invention. The flexural modulus should be as high as possible so as to prevent decrease in dimensional accuracy due to heating. It is usually about 7×10³ to 20×10³ MPa, particularly 8×10³ to 14×10³ MPa, in view of the resin properties.

The above-mentioned flexural modulus may be adjusted by controlling the composition of the above-mentioned electrically conductive resin compound. To be concrete, it is possible to control the composition by properly selecting the resin component and additives (reinforcing inorganic filler and conducting material) and their mixing ratio.

The cylindrical base constituting the photosensitive drum according to the sixth aspect of the present invention is a resin pipe formed from an electrically conductive resin compound having a flexural modulus as specified above. Usually, it has separately molded flanges 2a and 2b firmly fitted into both ends thereof, as shown in FIG. 1. At least either of the flanges 2a and 2b may be formed integrally with the cylindrical base 1 from the above-mentioned electrically conductive resin compound pertaining to the present invention. The flange has high strength and stiffness owing to incorporation with the above-mentioned inorganic filler for reinforcement, so that the flange may be formed integrally with the driving gear 6.

The photosensitive drum according to the sixth aspect of the present invention consists of the cylindrical base 1 (which is formed from the electrically conductive resin compound having the flexural modulus specified above) and the photosensitive layer 3 formed on the outer surface of the cylindrical base 1, as shown in FIG. 1. The photosensitive layer 3 is formed by coating the outer surface of the cylindrical base 1 with a solution of a photosensitive material and a binder in an organic solvent (such as alcohol, chloroform, and toluene). The coating layer is subsequently dried by heating. Since the cylindrical base 1 is formed from the electrically conductive resin compound having a high flexural modulus, the photosensitive drum according to the present invention does not change in outside diameter and straightness, while keeping good dimensional accuracy, when it is heated at a high temperature for drying. Thus it keeps good dimensional accuracy when the photosensitive layer 3 is formed and the resulting photosensitive drum has good dimensional accuracy. In addition, the resin pipe used as the cylindrical base mentioned above is very little subject to shrinkage due to cooling and solidifying at the time of injection molding. Incidentally, the coating solution for the photosensitive layer 3 may be any known one and the layer structure of the photosensitive layer 3 may also be any known one.

The photosensitive drum according to the seventh aspect of the present invention to achieve the seventh object of the present invention is constructed of the base consisting of a resin pipe (formed from a resin material having a flexural strength no lower than 100 MPa) and flanges firmly fitted into its openings.

The resin material from which the resin pipe is formed may be a single synthetic resin so long as it has a flexural strength as specified above. The resin material may also be a resin compound composed of an ordinary thermoplastic resin or a mixture of a plurality of thermoplastic resins and a conducting material and reinforcing inorganic filler dispersed therein.

The resin component constituting the resin compound is not specifically restricted so long as the resulting resin compound has a flexural strength no lower than 100 MPa. A polyamide resin is preferable because it gives a resin pipe having smooth surface (desirable for the photosensitive layer) good chemical resistance and good mechanical strength. A preferred polyamide resin is at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The components to be incorporated into the resin compound are the same as those mentioned in the second aspect of the present invention. Their amount is the same as that in the second aspect of the present invention.

In the seventh aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance lower than 10⁶ Ω/□, preferably lower than 10⁵ Ω/□, more preferably lower than 10⁴ Ω/□.

In the seventh aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness.

The photosensitive drum according to the seventh aspect of the present invention is a cylindrical body whose base is formed from the above-mentioned electrically conductive resin compound. The cylindrical base may be formed by any known method, such as injection molding and extrusion molding, the former being preferable. Molding may be carried out under ordinary conditions (for temperature and pressure).

The photosensitive drum according to the seventh aspect of the present invention is characterize in that the resin pipe as its base is formed from the above-mentioned resin material having a flexural strength no lower than 100 MPa, preferably no lower than 200 MPa. The resin pipe is exempt from damage due to load at the time of flange fitting, and this contributes to efficient production of the photosensitive drum. The flexural strength should be as high as possible from the standpoint of preventing damage at the time of flange fitting. However, an excessively high flexural strength prevents the flange from being firmly fixed, and the resulting photosensitive drum is subject to deformation and incapable of producing good images constantly. Therefore, the flexural strength should be 100-350 MPa, particularly 100-350 MPa. The flexural strength is measured by the method provided in ASTM D-790.

The above-mentioned flexural strength may be adjusted by controlling the composition of the above-mentioned resin material. To be concrete, it is possible to control the composition by properly selecting the resin component and additives (reinforcing inorganic filler and conducting material) and their mixing ratio.

The cylindrical base made of the above-mentioned electrically conductive resin compound has its outer surface finished in any surface roughness which is not specifically restricted. The outer surface may have the same surface roughness as that in the first aspect of the present invention.

The photosensitive drum according to the seventh aspect of the present invention consists of the above-mentioned resin pipe (as the base) and separately molded resin flanges which are pressure-fitted into either or both of the open ends thereof. The flange is molded in such a way that its outside diameter is slightly larger (about 100 μm) than the opening of the resin pipe, so that the flange is snugly fitted into the opening of the resin pipe. The resin pipe, which is formed from the resin material having a flexural strength no lower than 100 MPa, resists load due to flange fitting without breaking or being cracked, and hence it permits the flanges to be fitted firmly.

The flanges are molded from an ordinary resin material which is used for the base of the photosensitive drum or from the same resin material as used for the resin pipe. The flange may have the driving gear molded integrally therewith, as exemplified by flange 2b shown in FIG. 1. Usually, two flanges are fitted into both open ends of the resin pipe as shown in FIG. 1; alternatively, one flange is fitted into one open end of the resin pipe and the other flange is molded integrally with the resin pipe. The second flange may be molded integrally with the driving gear.

The photosensitive drum according to the seventh aspect of the present invention consists of a base and a photosensitive layer formed on its outer surface, said base being the above-mentioned resin pipe having flanges fitted therein. The photosensitive layer may be formed from any known material of any known composition. In addition, the photosensitive layer may have any known layer structure. The photosensitive layer may be formed before or after the flanges have been fitted into the resin pipe.

The photosensitive drum according to the eighth aspect of the present invention is characterized in that its cylindrical base is a resin pipe formed from an electrically conductive resin compound having a thermal conductivity no lower than 0.2 W/m·K.

The resin component constituting the electrically conductive resin compound is not specifically restricted so long as it gives the thermal conductivity as specified above. A polyamide resin is preferable because of its good chemical resistance and mechanical strength and its ability to give good surface smoothness. It is at least one species selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

The components to be incorporated into the resin compound are the same as those mentioned in the second aspect of the present invention. Their amount is the same as that in the second aspect of the present invention.

In the eighth aspect of the present invention, there are no restrictions on the amount of the conducting material such as carbon black; however, a desirable amount is 5-30 weight %, particularly 5-20 weight %, of the resin compound. In the case where the resin compound is to be used for the cylindrical base of the photosensitive drum, the amount of carbon black should be adjusted so that the resulting molded product has a surface resistance lower than 10⁶ Ω/□, preferably lower than 10⁵ Ω/□, more preferably lower than 10⁴ Ω/□.

In the eighth aspect of the present invention, the amount of inorganic filler is properly selected without specific restrictions according to the kind of the filler and the length and diameter of fiber. It is usually 1-30 weight %, preferably 5-25 weight %, more preferably 10-25 weight %, of the resin compound. The inorganic filler remarkably improves the strength and stiffness of the molded product without adverse effect on the surface smoothness.

The photosensitive drum according to the eighth aspect of the present invention is characterized in that its cylindrical base is formed from the above-mentioned electrically conductive resin compound which has a thermal conductivity no lower than 0.2 W/m·K, preferably no lower than 0.3 W/m·K. Because of this property, the resulting cylindrical base has improved coatability for the photosensitive layer, which contributes to the efficient production of the high-performance photosensitive drum. With a thermal conductivity lower than 0.2 W/m·K, the cylindrical base is low in temperature rise when it is heated for solvent removal after the coating solution has been applied to form the photosensitive layer. Thus, it takes a long time to remove solvent, which lowers productivity or causes incomplete solvent removal. (Solvent remaining unremoved makes the coating film to suffer dewetting, and the resulting photosensitive drum is poor in printing performance.) The thermal conductivity should be as high as possible so as to increase productivity. It is usually about 0.2-1 W/m·K, preferably 0.3-0.5 W/m·K, in view of the resin properties.

The above-mentioned thermal conductivity may be adjusted by controlling the composition of the above-mentioned electrically conductive resin compound. To be concrete, it is possible to control the composition by properly selecting the resin component and additives (reinforcing filler and conducting material) and their mixing ratio.

The photosensitive drum according to the eighth aspect of the present invention is characterized in that its cylindrical base is a resin pipe formed from the above-mentioned resin compound having a specific thermal conductivity. The method of forming the resin pipe from such a resin material is the same one as illustrated in the third aspect of the present invention.

The cylindrical base constituting the photosensitive drum according to the eighth aspect of the present invention is a resin pipe formed from the above-mentioned electrically conductive resin compound having a thermal conductivity as specified above. Usually, it has separately molded flanges 2a and 2b firmly fitted into both ends thereof, as shown in FIG. 1. At least either of the flanges 2a and 2b may be formed integrally with the cylindrical base from the above-mentioned electrically conductive resin compound pertaining to the present invention. The flange has high strength and stiffness owing to incorporation with the above-mentioned inorganic filler for reinforcement, so that the flange may be formed integrally with the driving gear 6.

The photosensitive drum according to the eighth aspect of the present invention consists of the cylindrical base 1 (which is formed from the electrically conductive resin compound having the thermal conductivity specified above) and the photosensitive layer 3 formed on the outer surface of the cylindrical base 1, as shown in FIG. 1. The photosensitive layer 3 is formed by coating the outer surface of the cylindrical base 1 with a solution of a photosensitive material and a binder in an organic solvent (such as alcohol, chloroform, and toluene). The coating layer is subsequently dried by heating. Since the cylindrical base 1 is formed from the electrically conductive resin compound having a high thermal conductivity, the photosensitive layer 3 is freed of solvent almost completely in a short time. Therefore, it is possible to efficiently produce high-performance photosensitive drums. Incidentally, the coating solution for the photosensitive layer 3 may be any known one and the layer structure of the photosensitive layer 3 may also be any known one.

### EXAMPLES

The invention will be described in more detail with reference to the following examples and comparative examples which are not intended to restrict the scope of the present invention.

### Example 1 and Comparative Examples 1 to 3

A mixture of pellets of different kind was prepared from a base resin in pellet form and a resin material A in pellet form (both having the composition shown below) by dry blending in a tumbler. Also, a mixed resin in pellet form was prepared from the above-mentioned base resin and resin material A by uniform extrusion-mixing in a twin-screw extruder and ensuing palletizing. Each sample was injection-molded into a cylindrical base for the photosensitive drum, measuring 30 mm in outside diameter, 275 mm in length, and 2 mm in wall thickness. Injection molding employed the same mold.

Base Polymer:

Nylon-66 (“Novamide” from Mitsubishi Enpla) 73 weight %

Carbon black (“Ketjen black” from Lion) 12 weight %

Potassium titanate whisker (“Dentol” from Outsuka Kagaku) 15 weight %

Resin Material A:

Nylon MXD6 (“Reny” from Mitsubishi Enpla)

Dry Blending:

Two kinds of pellets of the same size were mixed for 15 minutes in a tumbler (200 liters) turning at about 50 rpm. The mixed pellets were melted in a molding machine and the melt was blended in its molten state by the screw of the molding machine, and the melt mixture was finally injection molded.

Uniform Mixing:

This is common practice to prepare a resin compound. Two kinds of resins (in pellet or powder form) and inorganic fillers were fed into a twin-screw extruder for mixing, and the extrudate was pelletized. The thus obtained pellets of mixed resin were fed into a molding machine. Uniform mixing differs from dry blending in that the resulting mixture is in the form of pellet of one kind.

The cylindrical base thus obtained was measured for surface roughness (center line average height (Ra) and maximum height (Rmax)). This measurement was carried out according to JIS B0601 by using a surface roughness meter “Surfcom” made by Tokyo Seimitshusha. The results are shown in Table 2.

TABLE 2

| | Base | | | Surface | | |
|---|---|---|---|---|---|---|
| | material | Resin A | | roughness | | |
| | (weight | (weight | Blending | (μm) | | Rat- |
| | %) | %) | method | Ra | Rmax | ing |
| Example 1 | 85 | 15 | Dry blending | 0.03 | 0.37 | Good |
| Comparative | 100 | 0 | — | 0.25 | 1.34 | Poor |
| Example 1 | | | | | | |
| Comparative | 85 | 15 | Uniform mixing | 0.16 | 0.88 | Poor |
| Example 2 | | | | | | |
| Comparative | 80 | 20 | Uniform mixing | 0.1 | 0.66 | Poor |
| Example 3 | | | | | | |

It is noted from Table 2 that the cylindrical base formed from mixed pellets (prepared by dry blending according to the first aspect of the present invention) is superior in surface smoothness to the one formed from a mixed resin prepared by uniform mixing in Comparative Example.

### Examples 2 and 3 and Comparative Example 4

An electrically conductive resin compound of the following composition was prepared in the usual way, and it was formed by injection molding into a cylindrical base for the photosensitive drum, measuring 30 mm in outside diameter, 230 mm in length, and 2 mm in wall thickness. Injection molding employed the same mold and was carried out under the same conditions for all the samples. The resulting cylindrical base underwent annealing under the conditions shown in Table 3. (The comparative sample did not undergo annealing.) The annealed samples were examined for dimensional change with time. The results are shown in Table 3.

Electrically Conductive Resin Compound:

Nylon-66 (“Novamide” from Mitsubishi Empla) 50 weight %

Carbon black (“Ketjen Black” from Lion) 15 weight %

Potassium titanate whisker (“Dentol” from Outsuka Kagaku) 15 weight %

Nylon MXD6 (“Reny” from Mitsubishi Enpla) 20 weight %

TABLE 3

| | | Dimensional change with time after annealing | | | | | |
|---|---|---|---|---|---|---|---|
| | | in terms of outside diameter of resin pipe (mm) | | | | | |
| | | | 24 h | 48 h | 96 h | 240 h | Rating of |
| | Anneal- | Before | after | after | after | after | dimensional |
| | ing | annealing | annealing | annealing | annealing | annealing | change |
| Example 2 | 120° C. | 29.96 | 29.96 | 29.95 | 29.95 | 29.95 | Small |
| | 60 min | | | | | | |
| Example 3 | 100° C. | 29.95 | 29.95 | 29.94 | 29.94 | 29.94 | Small |
| | 60 min | | | | | | |
| Comparative | Not | 29.95 | 29.94 | 29.94 | 29.92 | 29.88 | Large |
| Example 4 | annealed | | | | | | |

It is noted from Table 3 that the cylindrical base, which underwent annealing at 100-140° C. (within the range specified in the second aspect of the present invention), is superior in dimensional stability, with a very small change after annealing.

### Examples 4 to 7 and Comparative Examples 5 and 6

An electrically conductive resin compound having the composition as shown in Table 4 was prepared in the usual way. It was injection-molded into a cylindrical base for the photosensitive drum, measuring 30 mm in outside diameter, 230 mm in length, and 2 mm in wall thickness. The molded product was examined for surface roughness by using a surface roughness meter “Surfcom” (made by Tokyo Seimitsusha) according to JIS B0601. Injection molding employed the same mold and was carried out under the same conditions for all the samples. The electrically conductive resin compound is composed of the following components.

PA66: “Novamide” from Mitsubishi Enpla

PA6: “UBE Nylon” from Ube Kosan

PAMXD6: “Reny” from Mitsubishi Enpla

Carbon black: “Ketjen Black” from Lion

Potassium titanate whisker: “Dentol” from Outsuka Kagaku

The thus obtained cylindrical base was coated by dipping with a solution for the photosensitive layer specified below. The coating layer was dried by heating at 120° C. for 60 minutes. The cylindrical base was examined for coatability for the photosensitive layer. The resulting photosensitive drum was mounted on a laser beam printer and examined for printing performance. The results are shown in Table 4.

Coating Solution for the Photosensitive Layer:

First layer (charge-generating layer)

Binder resin: polyvinyl butyral, 50%

Photosensitizer(CGM): phthalocyanine, 50%

Solvent: chloroform

Second layer (charge-transfer layer)

Binder resin: polycarbonate, 50%

Photosensitizer(CTM): diphenylhydrazone, 50%

Solvent: chloroform

TABLE 4

| | Composition | | | | | Surface | | | |
|---|---|---|---|---|---|---|---|---|---|
| | (weight %) | | | | | roughness | | | |
| | | | | Carbon | | (μm) | | Coat- | Printing |
| | PA66 | PAMXD6 | PA6 | black | Whisker | Ra | Rmax | ability | performance |
| Example 4 | 45 | 25 | 0 | 12 | 18 | 0.07 | 0.57 | Good | Good |
| Example 5 | 35 | 35 | 0 | 12 | 18 | 0.03 | 0.45 | Good | Good |
| Example 6 | 45 | 0 | 25 | 12 | 18 | 0.1 | 0.78 | Good | Good |
| Example 7 | 35 | 0 | 35 | 12 | 18 | 0.06 | 0.61 | Good | Good |
| Comparative | 70 | 0 | 0 | 12 | 18 | 0.36 | 1.03 | Poor¹⁾ | Poor³⁾ |
| Example 5 | | | | | | | | | |
| Comparative | 60 | 0 | 0 | 12 | 28 | 0.45 | 1.26 | Poor²⁾ | Poor³⁾ |
| Example 6 | | | | | | | | | |

¹⁾blotted with dark green spots
²⁾blotted with yellow-green spots
³⁾blotted with black spots

It is noted from Table 4 that the cylindrical base pertaining to the third aspect of the present invention has surface roughness such that the center-line average height (Ra) is lower than 0.2 μm and the maximum height (Rmax) is lower than 0.8 μm. Because of its smooth surface, the cylindrical base offered good coatability for the photosensitive layer without blotting with dark green spots or yellow green spots. This good coatability led to good printing performance.

### Examples 8 and 9 and Comparative Examples 7 to 9

An electrically conductive resin compound having the composition as shown in Table 5 was prepared in the usual way. It was injection-molded into a cylindrical base for the photosensitive drum, measuring 30 mm in outside diameter, 230 mm in length, and 2 mm in wall thickness. The molded product was examined for Vickers hardness on its outer surface. The results are shown in Table 5. Injection molding employed the same mold and was carried out under the same conditions for all the samples. The electrically conductive resin compound is composed of the following components. Samples of resin compound excluding whisker and carbon black were prepared, and they were injection molded into test pieces. The Vickers hardness of the test pieces was measured. The measured hardness is regarded as the hardness of the base resin. The results are also shown in Table 5.

PA66: “Novamide” from Mitsubishi Enpla

PA6: “UBE Nylon” from Ube Kosan

PAMXD6: “Reny” from Mitsubishi Enpla

Carbon black: “Ketjen Black” from Lion

Potassium titanate whisker: “Dentol” from Outsuka Kagaku

The thus obtained cylindrical base was annealed at 120° C. for 60 minutes and then coated by dipping with a solution for the photosensitive layer specified below. The coating layer was dried by heating at 120° C. for 60 minutes. The outer surface of the cylindrical base (before coating) was examined for scratches by using a microscope. The surface of the photosensitive drum (after coating) was examined for the state of the photosensitive layer. The results are shown in Table 5.

Coating Solution for the Photosensitive Layer:

First layer (charge-generating layer)

Binder resin: polyvinyl butyral, 50%

Photosensitizer: phthalocyanine, 50%

Solvent: chloroform

Second layer (charge-transfer layer)

Binder resin: polycarbonate, 50%

Photosensitizer: diphenylhydrazone, 50%

Solvent: chloroform

The thus obtained photosensitive drum was mounted on a laser beam printer and its printing performance was evaluated by actual printing. The results are shown in Table 5.

TABLE 5

| | | | | | | Vickers | | | | |
|---|---|---|---|---|---|---|---|---|---|---|
| | Composition | | | | | hardness | | Surface | | |
| | (weight %) | | | | | | Cylin- | state | | Printing |
| | | | | | Carbon | Base | drical | of | Coat- | Perfor- |
| | PA66 | PA6 | PAMXD6 | Whisker | black | resin | base | base | ability | mance |
| Example 8 | 30 | | 40 | 20 | 10 | 35 | 38 | Good | Good | Good |
| Example 9 | 30 | | 45 | 15 | 10 | 21 | 25 | Good | Good | Good |
| Comparative | 50 | | 30 | 10 | 10 | 13 | 16 | Poor¹⁾ | Poor³⁾ | Poor⁵⁾ |
| Example 7 | | | | | | | | | | |
| Comparative | 50 | 30 | | 10 | 10 | 9 | 12 | Poor¹ | Poor³⁾ | Poor⁵⁾ |
| Example 8 | | | | | | | | | | |
| Comparative | 40 | 45 | | 5 | 10 | 4 | 7 | Poor²⁾ | Poor⁴⁾ | Poor⁶⁾ |
| Example 9 | | | | | | | | | | |

¹⁾damaged by scratches
²⁾damaged by many scratches
³⁾blotted with dark green spots
⁴⁾blotted with yellow green spots
⁵⁾blotted with black spots
⁶⁾blotted with many black spots

It is noted from Table 5 that the cylindrical base (pertaining to the fourth aspect of the present invention), which is formed from an electrically conductive resin compound whose base resin has a Vickers hardness higher than 15, is very little vulnerable to scratches on its surface during post-treatment after demolding. Therefore, it offers good coatability for the photosensitive layer without blotting with dark green or yellow green spots. Thus the resulting photosensitive drum exhibits good printing performance. It is also noted from Table 5 that filling with a larger amount of whisker effectively improves the surface hardness of the cylindrical base.

### Examples 10 and 11 and Comparative Example 10 to 12

An electrically conductive resin compound having the composition as shown in Table 6 was prepared in the usual way. It was injection-molded into a resin pipe measuring 30 mm in outside diameter, 230 mm in length, and 2 mm in wall thickness. Injection molding employed the same mold and was carried out under the same conditions for all the samples. The electrically conductive resin compound is composed of the following components. Samples of resin compound excluding whisker and carbon black were prepared, and they were injection molded into test pieces. The samples were examined for the coefficient of linear expansion according to ASTM D-696. The results are shown in Table 6.

PA66: “Novamide” from Mitsubishi Enpla

PA6: “UBE Nylon” from Ube Kosan

PAMXD6: “Reny” from Mitsubishi Enpla

Carbon black: “Ketjen Black” from Lion

Potassium titanate whisker: “Dentol” from Outsuka Kagaku

The thus obtained resin pipe was measured for outside diameter at its both ends (end A and end B) and was also examined for straightness over its entire length. The results are shown in Table 6. Incidentally, “straightness” is a measure to represent the geometrical tolerance as defined in JIS B0021. It is measured in the following way.

Measurement of Straightness:

The resin pipe is placed approximately parallel with the reference edge having a high straightness accuracy. The distance between the resin pipe and the reference edge is measured by using a laser transmitter-detector which is moved in the lengthwise direction. The distance measured is plotted against the length, and a reference line connecting ends is drawn. The maximum deviation from the reference line is regarded as the straightness.

TABLE 6

| | | | | | | Coefficient | | | | | |
|---|---|---|---|---|---|---|---|---|---|---|---|
| | | | | | | of linear | | | | Difference | |
| | Composition | | | | | expansion × | | Outside | | in outside | |
| | (weight %) | | | | | 10⁻⁵/K | | diameter | | Straight- | |
| | | | | | Carbon | Resin | Base | (mm) | | (μm) | ness |
| | PA66 | PA6 | PAMXD6 | Whisker | black | compound | resin | End A | End B | (A − B) | (μm) |
| Example 10 | 30 | | 40 | 20 | 10 | 2.5 | 8.5 | 29.961 | 29.956 | 5 | 27 |
| Example 11 | 30 | | 45 | 15 | 10 | 3.8 | 7.8 | 29.952 | 29.943 | 9 | 35 |
| Comparative | 50 | | 30 | 10 | 10 | 4.5 | 12.3 | 29.934 | 29.896 | 38 | 88 |
| Example 10 | | | | | | | | | | | |
| Comparative | 50 | 30 | | 10 | 10 | 5.2 | 12.7 | 29.944 | 29.888 | 56 | 95 |
| Example 11 | | | | | | | | | | | |
| Comparative | 40 | 45 | | 5 | 10 | 6.8 | 13.5 | 29.943 | 29.853 | 90 | 109 |
| Example 12 | | | | | | | | | | | |

In this example pertaining to the fifth aspect of the present invention, the resin pipe was obtained by injection molding from a resin compound whose base resin has a coefficient of linear expansion smaller than 1.0×10⁻⁴/K. It is noted from Table 6 that the resin pipe is very little vulnerable to shrinkage that takes place during cooling and solidifying after injection molding. Therefore, it has a very small difference in outside diameters and very little fluctuation in straightness. In other words, it is superior in dimensional accuracy. Thus, this resin pipe is used as the cylindrical base for the photosensitive drum which has good dimensional accuracy and high performance.

### Examples 12 and 13 and Comparative Examples 13 to 15

An electrically conductive resin compound having the composition as shown in Table 7 was prepared in the usual way. It was injection-molded into a cylindrical base for the photosensitive drum, measuring 30 mm in outside diameter, 275 mm in length, and 2 mm in wall thickness. Injection molding employed the same mold and was carried out under the same conditions for all the samples. The electrically conductive resin compound is composed of the following components. Test pieces were prepared from the same resin compound. They were tested for flexural modulus according to ASTM D-790. The results are shown in Table 7.

PA66: “Novamide” from Mitsubishi Enpla

PA6: “UBE Nylon” from Ube Kosan

PAMXD6: “Reny” from Mitsubishi Enpla

Carbon black: “Ketjen Black” from Lion

Potassium titanate whisker: “Dentol” from Outsuka Kagaku

The thus obtained cylindrical base was allowed to stand at 120° C. for 60 minutes. After cooling, it was measured for outside diameter at its both ends (end A and end B) and was also examined for straightness over its entire length. The results are shown in Table 7. Incidentally, “straightness” is a measure to represent the geometrical tolerance as defined in JIS B0021. It is measured in the following way.

Measurement of Straightness:

The cylindrical base is placed approximately parallel with the reference edge having a high straightness accuracy. The distance between the cylindrical base and the reference edge is measured by using a laser transmitter-detector which is moved in the lengthwise direction. The distance measured is plotted against the length, and a reference line connecting ends is drawn. The maximum deviation from the reference line is regarded as the straightness.

TABLE 7

| | | | | | | | | | Difference | |
|---|---|---|---|---|---|---|---|---|---|---|
| | Composition | | | | | | Outside | | in outside | |
| | (weight %) | | | | | Flexural | diameter | | diameter | Straight- |
| | | | | | Carbon | modulus | (mm) | | (μm) | ness |
| | PA66 | PA6 | PAMXD6 | Whisker | black | ×10³ MPa | End A | End B | (A − B) | (μm) |
| Example 12 | 30 | | 40 | 20 | 10 | 12.5 | 29.831 | 29.825 | 6 | 31 |
| Example 13 | 30 | | 45 | 15 | 10 | 8.3 | 29.841 | 29.833 | 8 | 39 |
| Comparative | 50 | | 30 | 10 | 10 | 5.8 | 29.851 | 29.822 | 29 | 86 |
| Example 13 | | | | | | | | | | |
| Comparative | 50 | 30 | | 10 | 10 | 4.5 | 29.853 | 29.812 | 41 | 92 |
| Example 14 | | | | | | | | | | |
| Comparative | 40 | 45 | | 5 | 10 | 3.7 | 29.881 | 29.795 | 86 | 106 |
| Example 15 | | | | | | | | | | |

In this example pertaining to the sixth aspect of the present invention, the cylindrical base was obtained by injection molding from an electrically conductive resin compound which has a flexural modulus no lower than 7×10³ MPa. It is noted from Table 7 that the cylindrical base changes very little in outside diameter and straightness while keeping good dimensional accuracy even after heating at 120° C. for 60 minutes. The cylindrical base had its outer surface coated with the photosensitive layer. The resulting photosensitive drum changed very little in dimensions after drying with heat and retained good dimensional accuracy.

### Examples 14 and 15 and Comparative Examples 16 to 18

A resin compound having the composition as shown in Table 8 was prepared in the usual way. It was injection-molded into a resin pipe measuring 30 mm in outside diameter, 230 mm in length, and 2 mm in wall thickness. Injection molding employed the same mold and was carried out under the same conditions for all the samples. The resin compound is composed of the following components. Test pieces were prepared from the same resin compound. They were tested for flexural strength according to ASTM D-790. The results are shown in Table 8.

PA66: “Novamide” from Mitsubishi Enpla

PA6: “UBE Nylon” from Ube Kosan

PAMXD6: “Reny” from Mitsubishi Enpla

Carbon black: “Ketjen Black” from Lion

Potassium titanate whisker: “Dentol” from Outsuka Kagaku

The thus obtained resin pipe was tested for strength by measuring a load required to break the resin pipe when an inverted conical tool is forced into one opening of the resin pipe firmly held vertically. The load measurement was carried out with an Instron tester. The results are shown in Table 8. The resin pipe was converted into the base for the photosensitive drum by fitting flanges into its open ends. The open ends of the resin pipe were visually inspected for damage by fitting. The results are shown in Table 8. Incidentally, the flange has a diameter slightly larger by about 100 μm than the inside diameter of the open end of the resin pipe.

TABLE 8

| | Composition | | | | | | | |
|---|---|---|---|---|---|---|---|---|
| | (weight %) | | | | | Flexural | Load to | |
| | | | | | Carbon | strength | break | Flange |
| | PA66 | PA6 | PAMXD6 | Whisker | black | (MPa) | (kgf) | fitting |
| Example 14 | 30 | | 40 | 20 | 10 | 233 | 87 | Not broken |
| Example 15 | 30 | | 45 | 15 | 10 | 145 | 72 | Not broken |
| Comparative | 50 | | 30 | 10 | 10 | 87 | 48 | Broken |
| Example 16 | | | | | | | | |
| Comparative | 50 | 30 | | 10 | 10 | 65 | 42 | Broken |
| Example 17 | | | | | | | | |
| Comparative | 40 | 45 | | 5 | 10 | 49 | 37 | Broken |
| Example 18 | | | | | | | | |

In this example the resin pipe was prepared from the resin material having a flexural strength no lower than 100 MPa according to the seventh aspect of the present invention. It is noted from Table 8 that the resulting resin pipe is strong enough to permit the fitting of the flange without damage to the open end when it is converted into the base of the photosensitive drum.

### Examples 16 and 17 and Comparative Examples 19 to 21

An electrically conductive resin compound having the composition as shown in Table 9 was prepared in the usual way. It was injection-molded into a cylindrical base for the photosensitive drum, measuring 30 mm in outside diameter, 230 mm in length, and 2 mm in wall thickness. Injection molding employed the same mold and was carried out under the same conditions for all the samples. The resin compound is composed of the following components.

PA66: “Novamide” from Mitsubishi Enpla

PA6: “UBE Nylon” from Ube Kosan

PAMXD6: “Reny” from Mitsubishi Enpla

Carbon black: “Ketjen Black” from Lion

Potassium titanate whisker: “Dentol” from Outsuka Kagaku

The thus obtained cylindrical base had its outer surface coated with a solution of the following composition. The coating layer was dried by heating at 120° C. for 60 minutes for solvent removal. In this way there was obtained a photosensitive drum consisting of the cylindrical base and the photosensitive layer formed on its outer surface.

First layer (charge-generating layer)

Binder resin: polyvinyl butyral, 50%

Photosensitizer: phthalocyanine, 50%

Solvent: chloroform

Second layer (charge-transfer layer)

Binder resin: polycarbonate, 50%

Photosensitizer: diphenylhydrazone, 50%

Solvent: chloroform

The coating film (photosensitive layer) formed on the outer surface of the photosensitive drum was visually inspected. The results are shown in Table 9.

The thus obtained photosensitive drum was mounted on a laser beam printer and its printing performance was evaluated by actual printing. The results are shown in Table 9.

TABLE 9

| | Composition | | | | | | | |
|---|---|---|---|---|---|---|---|---|
| | (weight %) | | | | | Thermal | | |
| | | | | | Carbon | conductivity | Coating | Printing |
| | PA66 | PA6 | PAMXD6 | Whisker | black | (W/m · K) | film | performance |
| Example 16 | 30 | | 40 | 20 | 10 | 0.4 | good | good |
| Example 17 | 30 | | 45 | 15 | 10 | 0.25 | good | good |
| Comparative | 50 | | 30 | 10 | 10 | 0.15 | poor¹⁾ | poor²⁾ |
| Example 19 | | | | | | | | |
| Comparative | 50 | 30 | | 10 | 10 | 0.12 | poor¹⁾ | poor²⁾ |
| Example 20 | | | | | | | | |
| Comparative | 40 | 45 | | 5 | 10 | 0.1 | poor¹⁾ | poor²⁾ |
| Example 21 | | | | | | | | |

¹⁾Dewetting
²⁾Black spots

In this example the cylindrical base was prepared from the electrically conductive resin compound having a thermal conductivity no lower than 0.2 W/m·K according to the eighth aspect of the present invention. It is noted from Table 9 that the cylindrical base permits a good photosensitive layer to be formed thereon by drying with heating at 120° C. for 60 minutes. The resulting photosensitive drum is superior in productivity as well as printing performance.

Effect of the Invention

The mixed resin compound according to the first aspect of the present invention is superior in surface smoothness even when it is filled with carbon black and reinforcing fiber and hence it is suitable for the base of the photosensitive drum.

The production process according to the second aspect of the present invention readily provides resin pipes which are light in weight and superior in strength and dimensional stability and hence are suitable for use as the base of the photosensitive drum.

The photosensitive drum according to the third aspect of the present invention is formed from a cylindrical base which has the surface roughness such that the center line average height (Ra) is no larger than 0.2 μm and the maximum height (Rmax) is no larger than 0.8 μm. This cylindrical base permits a good photosensitive layer to be coated thereon efficiently. The resulting photosensitive layer ensures good printing performance.

The photosensitive drum according to the fourth aspect of the present invention is based on a cylindrical base formed from an electrically conductive resin compound whose base resin has a Vickers hardness no lower than 15. The cylindrical base is very little vulnerable to damage at the time of demolding and post-treatment. Thus it has good coatability and permits a good photosensitive layer to be coated thereon. This leads to good printing performance.

The resin pipe according to the fifth aspect of the present invention is very little subject to shrinkage that takes place in the cooling and solidifying cycle of injection molding and hence it has high dimensional accuracy while keeping its accurate outside diameter and straightness. The resin pipe is used as the cylindrical base for the photosensitive drum which exhibits good image characteristics and high printing performance.

The photosensitive drum according to the sixth aspect of the present invention is based on a cylindrical base which is formed from an electrically conductive resin compound having a flexural modulus no lower than 7×10³ MPa. It does not change in outside diameter and straightness when it is exposed to high temperature (for drying) in the step of coating the cylindrical base with a photosensitive layer. Therefore, it keeps good dimensional accuracy.

The photosensitive drum according to the seventh aspect of the present invention is based on a base (resin pipe) which is formed from a resin material having a flexural strength no lower than 100 MPa. This resin pipe does not break or not be cracked when flanges are fitted into its ends. When used as the cylindrical base, this resin pipe contributes to efficient production of photosensitive drums having uniform quality.

The photosensitive drum according to the eighth aspect of the present invention is based on the cylindrical base which is formed from an electrically conductive resin compound having a thermal conductivity no lower than 0.2 W/m·K. This cylindrical base has good coatability for the photosensitive layer and hence contributes to efficient mass production. The resulting photosensitive drum exhibits good printing performance without image defects such as black spots.

1. A mixed resin compound in a desired shape formed by injection molding from a molding material containing a mixed resin composed of two or more kinds of resins differing in the rate of crystallization, wherein said resins are mixed in pellet form and the resulting mixture of pellets is injection-molded as such.

2. The mixed resin compound as defined in claim 1, wherein said mixed resin comprises (A) at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%, and (B) at least one of the other resins.

3. The mixed resin compound as defined in claim 1, which contains an electrically conducting material dispersed therein.

4. The mixed resin compound as defined in claim 3, which contains carbon black as the electrically conducting material.

5. The mixed resin compound as defined in claim 4, which contains the carbon black in an amount of 5-30 weight %.

6. The mixed resin compound as defined in claim 1, which contains a reinforcing inorganic filler.

7. The mixed resin compound as defined in claim 6, which contains the reinforcing inorganic filler in an amount of 1-30 weight %.

8. A photosensitive drum consisting of a cylindrical base and a photosensitive layer formed on the outer surface thereof, wherein the cylindrical base is formed from the mixed resin compound as defined in claim 1.

9. A process for producing a resin pipe by injection molding from a thermoplastic resin or a resin compound based on said thermoplastic resin, wherein the molded product undergoes annealing after demolding.

10. A process for producing a resin pipe as defined in claim 9, wherein the resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

11. A process for producing a resin pipe as defined in claim 9, wherein the annealing is carried out at 100-140° C. for 0.5-2 hours.

12. A process for producing a resin pipe as defined in claim 9, wherein the resin pipe is an electrically conductive resin pipe formed by injection molding from an electrically conductive resin compound composed of a thermoplastic resin and an electrically conducting material dispersed therein.

13. A process for producing a resin pipe as defined in claim 12, wherein the electrically conductive resin compound contains carbon black as an electrically conducting material.

14. A process for producing a resin pipe as defined in claim 13, wherein the content of the carbon black is 5-30 weight %.

15. A process for producing a resin pipe as defined in claim 9, wherein the electrically conductive resin compound is one which contains a reinforcing inorganic filler dispersed therein.

16. A process for producing a resin pipe as defined in claim 15, wherein the content of the reinforcing inorganic filler is 1-30 weight %.

17. A process for producing a resin pipe as defined in claim 9, wherein the resin pipe is a base for a photosensitive drum.

18. A photosensitive drum consisting of a cylindrical base of electrically conductive resin compound and a photosensitive layer formed by coating on the outer surface of said cylindrical base, wherein the outer surface of the cylindrical base has a surface roughness equal to or smaller than 0.2 μm in terms of Ra (center line average height) and equal to or smaller than 0.8 μm in terms of Rmax (maximum height).

19. A photosensitive drum as defined in claim 18, wherein the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

20. A photosensitive drum as defined in claim 18, wherein the electrically conductive resin compound contains carbon black as an electrically conducting material.

21. A photosensitive drum as defined in claim 20, wherein the content of the carbon black is 5-30 weight %.

22. A process for producing a resin pipe as defined in claim 18, wherein the electrically conductive resin compound is one which contains a reinforcing inorganic filler dispersed therein.

23. A photosensitive drum as defined in claim 22, wherein the content of the reinforcing inorganic filler is 1-30 weight %.

24. A photosensitive drum consisting of a cylindrical base and a photosensitive layer formed by coating on the outer surface thereof, wherein the cylindrical base is an electrically conductive resin pipe formed from an electrically conductive resin compound which contains as a base resin having a Vickers hardness no lower than 15.

25. A photosensitive drum as defined in claim 24, wherein the base resin of the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

26. A photosensitive drum as defined in claim 24, wherein the electrically conductive resin compound contains carbon black as an electrically conducting material.

27. A photosensitive drum as defined in claim 26, wherein the content of the carbon black is 5-30 weight %.

28. A photosensitive drum as defined in claim 24, wherein the electrically conductive resin compound is one which contains a reinforcing inorganic filler dispersed therein.

29. A photosensitive drum as defined in claim 28, wherein the content of the reinforcing inorganic filler is 1-30 weight %.

30. A resin pipe obtained by injection molding from a thermoplastic resin or a resin compound based on said thermoplastic resin, wherein said thermoplastic resin or the base resin for said resin compound is a resin having a coefficient of linear expansion no larger than 1.0×10⁻⁴/K.

31. A resin pipe as defined in claim 30, which contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

32. A resin pipe as defined in claim 30, wherein the resin pipe is an electrically conductive resin pipe formed by injection molding from an electrically conductive resin compound composed of a thermoplastic resin and an electrically conducting material dispersed therein.

33. A resin pipe as defined in claim 32, wherein the electrically conductive resin compound contains carbon black as an electrically conducting material.

34. A resin pipe as defined in claim 33, wherein the content of the carbon black is 5-30 weight %.

35. A resin pipe as defined in claim 30, wherein the electrically conductive resin compound is one which contains a reinforcing inorganic filler dispersed therein.

36. A resin pipe as defined in claim 35, wherein the content of the reinforcing inorganic filler is 1-30 weight %.

37. A resin pipe as defined in claim 30, wherein the resin pipe is a base for a photosensitive drum.

38. A photosensitive drum consisting of a cylindrical base and a photosensitive layer formed by coating on the outer surface thereof, wherein the cylindrical base is a resin pipe defined in claim 30.

39. A photosensitive drum consisting of a cylindrical base and a photosensitive layer formed from a solution containing a photosensitive material by coating on the outer surface thereof, wherein the cylindrical base is an electrically conductive resin pipe formed from an electrically conductive resin compound which has a flexural modulus no lower than 7×10³ MPa.

40. A photosensitive drum as defined in claim 39, wherein the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

41. A photosensitive drum as defined in claim 39, wherein the electrically conductive resin compound contains carbon black as an electrically conducting material.

42. A photosensitive drum as defined in claim 41, wherein the content of the carbon black is 5-30 weight %.

43. A photosensitive drum as defined in claim 39, wherein the electrically conductive resin compound is one which contains a reinforcing inorganic filler dispersed therein.

44. A photosensitive drum as defined in claim 43, wherein the content of the reinforcing inorganic filler is 1-30 weight %.

45. A photosensitive drum made up of a resin pipe as a base, a photosensitive layer formed on the outer surface of the base, and a separately formed resin flange pressure-fitted into at least one open end of the base, wherein the resin pipe is formed from a resin material having a flexural strength no lower than 100 MPa.

46. photosensitive drum as defined in claim 45, wherein the resin material from which the resin pipe is formed is an electrically conductive resin compound containing at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

47. photosensitive drum as defined in claim 45, wherein the electrically conductive resin compound from which the resin pipe is formed contains carbon black as an electrically conducting material.

48. photosensitive drum as defined in claim 47, wherein the content of the carbon black is 5-30 weight %.

49. photosensitive drum as defined in claim 45, wherein the electrically conductive resin compound is one which contains a reinforcing inorganic filler dispersed therein.

50. photosensitive drum as defined in claim 49, wherein the content of the reinforcing inorganic filler is 1-30 weight %.

51. photosensitive drum consisting of a cylindrical base and a photosensitive layer formed on the outer surface thereof by coating and drying from a solution containing a photosensitive material, wherein the cylindrical base is an electrically conductive resin pipe formed from an electrically conductive resin having a thermal conductivity no lower than 0.2 W/m·K.

52. photosensitive drum as defined in claim 51, wherein the electrically conductive resin compound contains at least one resin component selected from a polyamide resin obtained from metaxylylenediamine and adipic acid, a polyamide resin obtained from ε-caprolactam, and an alloy resin obtained by blending a polyamide resin with a resin having a water absorption no higher than 0.3%.

53. photosensitive drum as defined in claim 51, wherein the electrically conductive resin compound contains carbon black as an electrically conducting material.

54. A photosensitive drum as defined in claim 53, wherein the content of the carbon black is 5-30 weight %.

55. A photosensitive drum as defined in claim 51, wherein the electrically conductive resin compound is one which contains a reinforcing inorganic filler dispersed therein.

56. A photosensitive drum as defined in claim 55, wherein the content of the reinforcing inorganic filler is 1-30 weight %.
